(19) United States
(12) Patent Application Publication
(10) Pub. No.: US 2026/0099168 A1
(43) Pub. Date: Apr. 9, 2026

(54) ELECTRONIC DEVICE FOR CALIBRATION AND CALIBRATION METHOD THEREOF

(71) Applicant: MagnaChip Semiconductor, Ltd., Cheongju-si (KR)

(72) Inventors: Gil Sung ROH, Cheongju-si (KR); Hyeong Seok KIM, Cheongju-si (KR)

(73) Assignee: MagnaChip Semiconductor, Ltd., Cheongju-si (KR)

(21) Appl. No.: 19/243,095

(22) Filed: Jun. 19, 2025

(30) Foreign Application Priority Data
Oct. 7, 2024 (KR) 10-2024-0135999

(51) Int. Cl. G06F 1/10; G06F 1/12

(52) U.S. Cl. CPC G06F 1/10; G06F 1/12

(57) ABSTRACT

An electronic device includes a first electronic device and a second electronic device configured to transmit and receive signals based on a C-PHY protocol. The second electronic device includes a calibrator configured to receive recovered data via a data path used to receive real data and provide a calibration value; and a clock recoverer configured to recover a clock signal (CLK) using the calibration value.

### CROSS-REFERENCE TO RELATED APPLICATION

This application claims the benefit under 35 U.S.C. § 119(a) of Korean Patent Application No. 10-2024-0135999, filed on Oct. 7, 2024, the entire disclosure of which is incorporated herein by reference for all purposes.

### BACKGROUND

### 1. Field

The present disclosure relates to an electronic device and a method for performing calibration prior to the transmission of real data between different electronic devices.

### 2. Description of the Background

Various protocols have been developed and used to enable data communication between different electronic devices. One such protocol is C-PHY. C-PHY is an interface designed to achieve high data throughput in environments where the data rate is limited, e.g., in mobile applications. C-PHY employs specific encoding methods, such as a 3-phase symbol encoding scheme. As a result, a clock data recovery (CDR) circuit receives three signals—AB, BC, and CA—and generates a clock signal. During this clock signal generation, jitter may occur. Jitter can lead to incorrect clock signal generation, which in turn may cause data transmission and reception errors.

To address jitter, a calibration function may be employed. The calibration function must be supported by both a first electronic device (transmitter) and a second electronic device (receiver). When the first electronic device transmits calibration data to the second electronic device, the second electronic device performs a calibration operation. This calibration involves identifying an appropriate delay value in a delay circuit included in the clock recoverer of the second electronic device. Once the calibration is completed, the second electronic device selects a delay step having the largest margin among all delay steps in the delay circuit, thereby enabling proper generation of the clock signal within the clock recoverer.

Conventionally, calibration is typically performed using only the clock signal without utilizing a data path. Accordingly, the coverage of such calibration is limited. Furthermore, since the clock signal is used for the calibration process, circuits such as phase-locked loops (PLLs) and delay-locked loops (DLLs) may be desired to generate the clock signal, making it difficult to optimize the chip area.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes a first electronic device and a second electronic device configured to transmit and receive signals based on a C-PHY protocol. The second electronic device includes a calibrator configured to receive recovered data via a data path used to receive real data and provide a calibration value; and a clock recoverer configured to recover a clock signal (CLK) using the calibration value.

The calibrator may include a pattern generator configured to output pattern data; a comparator configured to compare the recovered data transmitted through the data path with the pattern data and output a pass or fail status value of the recovered data; and a calibration setter configured to set the calibration value to a midpoint value of a pass region among the output values of the comparator.

The calibration setter may be configured to count a number of pass regions during preamble calibration, and, in response to two or more of the pass regions being detected, set the calibration value to a midpoint value of a longer one of the pass regions.

The pass or fail status may be determined based on whether synchronization between the recovered data and the pattern data is achieved.

The electronic device may further include a plurality of receivers configured to receive a plurality of signals, respectively, from the first electronic device; a data recoverer configured to output the plurality of received signals in synchronization with the clock signal recovered by the clock recoverer; and a signal processor configured to transmit the recovered data to a controller based on the clock signal and the plurality of received signals.

After completion of preamble calibration, the controller may be configured to receive the real data using a clock signal generated based on the calibration value set by the calibrator.

The calibrator may be configured to perform a guard period and a data checking period during preamble calibration, and determine that the recovered data is in a fail state in response to at least one data error occurring during the data checking period.

The calibrator may be configured to determine that the recovered data is in a fail state in response to the clock signal being missing during preamble calibration.

The clock recoverer may include a data transition detector and a delay generator. The delay generator may include a delay generation path and a self-reference comparator, and may be configured to minimize variations due to process, voltage, and temperature (PVT).

The delay generation path may include a power terminal and a ground terminal; a first MOSFET and a second MOSFET connected in series between the power terminal and the ground terminal; a first resistor connected between the first MOSFET and the second MOSFET; and two or more capacitor selectors connected between a first node between the first MOSFET and the second MOSFET and an output terminal. The first resistor and the capacitor selectors may be configured to provide an optimal delay path.

The self-reference comparator may offset the variations due to PVT using a MOSFET having a gate terminal connected to a drain terminal.

The self-reference comparator may include third to seventh MOSFETs configured to operate based on an output of the delay generation path; and a second resistor connected in series with the third MOSFET, and is configured to provide a self-reference voltage for level transition of a clock signal using a threshold voltage of the third MOSFET.

In another general aspect, an electronic device includes a first electronic device and a second electronic device configured to transmit and receive signals based on a C-PHY protocol. The second electronic device includes a clock recoverer, configured to recover a clock signal (CLK) using a calibration value, comprising a data transition detector and a delay generator. The delay generator includes a delay generation path and a self-reference comparator, and is configured to minimize variations due to process, voltage, and temperature (PVT).

The delay generation path may include a power terminal and a ground terminal; a first MOSFET and a second MOSFET connected in series between the power terminal and the ground terminal; a first resistor connected between the first MOSFET and the second MOSFET; and two or more capacitor selectors connected between a first node between the first and second MOSFETs and an output terminal. The delay generation path may include configured to provide an optimal delay path by the first resistor and the capacitor selectors.

The self-reference comparator may offset variations due to PVT using a MOSFET having a gate terminal connected to a drain terminal.

The self-reference comparator may include third to seventh MOSFETs configured to operate based on an output of the delay generation path; and a second resistor connected in series with the third MOSFET, and configured to provide a self-reference voltage for level transition of a clock signal using a threshold voltage of the third MOSFET.

In another general aspect, a calibration method using an electronic device includes performing a preamble calibration; receiving, by a second electronic device, pattern data from a first electronic device; receiving recovered data corresponding to a programmable delay upon transmitting the pattern data; identifying a data-pass region based on a result of evaluating the received recovered data; and setting a midpoint value of the data-pass region as a calibration value and transmitting the calibration value to a clock recoverer.

In response to a plurality of data-pass regions being identified, a midpoint value of a widest one of the data-pass regions may be set as the calibration value.

The second electronic device may perform the preamble calibration by repeatedly alternating between a guard period and a data checking period, and determine that the recovered data is in a fail status in response to at least one data error occurring during the data checking period.

In response to a clock signal missing during the preamble calibration, the second electronic device may determine that the recovered data is in a fail status.

Other features and aspects will be apparent from the following detailed description, the drawings, and the claims.

### BRIEF DESCRIPTION OF DRAWINGS

FIG. 1 is a block diagram illustrating a configuration of an electronic device for calibration according to an example of the present disclosure.

FIG. 2 is a block diagram illustrating a configuration of the calibrator shown in FIG. 1.

FIG. 3 is a timing diagram illustrating the concept of an eye mask and clock recovery.

FIG. 4 is a flowchart illustrating a process by which a calibrator sets a calibration value according to the present disclosure.

FIG. 5 is a diagram illustrating a sequence for performing preamble calibration according to the present disclosure.

FIG. 6 is a diagram illustrating an example of determining a data fail state when a clock signal is not generated during preamble calibration according to the present disclosure.

FIG. 7 is a graph and timing diagram illustrating conditions of a programmable delay path under variations in process, voltage, and temperature (PVT) conditions.

FIG. 8 is a block diagram illustrating a configuration of a clock recoverer 120 including a programmable delay path that is insensitive to PVT variation.

FIG. 9 is a block diagram illustrating a delay generator capable of providing a programmable delay path that is insensitive to PVT variation.

FIG. 10 is a circuit diagram of a delay generation path included in the delay generator.

FIG. 11 is a circuit diagram of a self-reference comparator included in the delay generator.

FIG. 12 is a graph and timing diagram illustrating the behavior of a programmable delay path under various conditions resulting from process, voltage, temperature (PVT) variation, according to the present disclosure.

FIG. 13 is a timing diagram of a clock recoverer including the delay generator that is insensitive to PVT variation.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An object of the present disclosure is to provide an electronic device and a calibration method that allow a calibration value to be determined using a data path designed for transmitting real data, thereby allowing the circuit configuration desired for calibration to be minimized.

Another object of the present disclosure is to provide an electronic device and a calibration method that allow a programmable delay path to be provided, the delay path being insensitive to variations caused by process, voltage, and temperature (PVT) in the circuit of the second electronic device.

The technical problems addressed by the present disclosure are not limited to those mentioned above, and additional technical problems not expressly stated herein will be readily understood after an understanding of this disclosure.

A detailed description is given below, with reference to attached drawings.

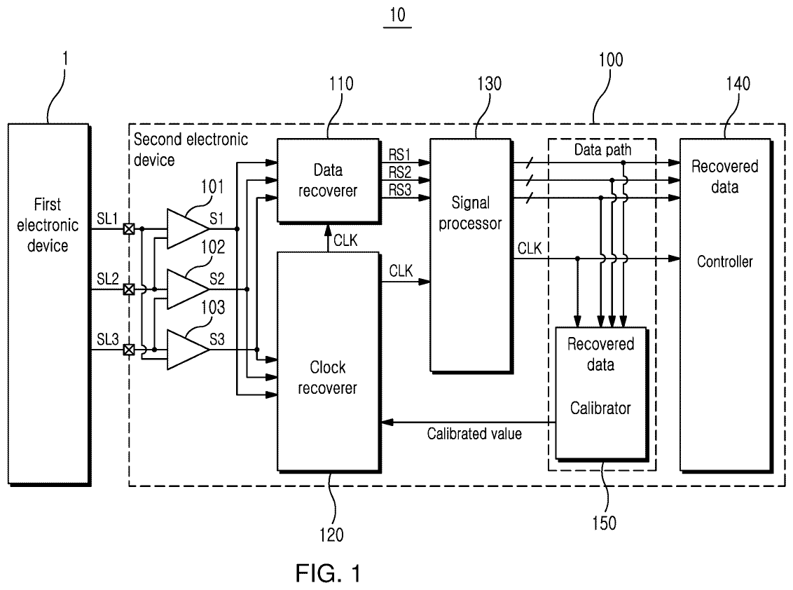

FIG. 1 is a block diagram illustrating a configuration of an electronic device for calibration according to an example of the present disclosure.

In FIG. 1, an electronic device 10 may include a first electronic device 1 and a second electronic device 100. The first electronic device 1 may function as a transmitter and may be, for example, an application processor (AP). The second electronic device 100 may function as a receiver and may be, for example, an integrated circuit (IC).

The first electronic device 1 may transmit signals based on a C-PHY protocol as defined by the Mobile Industry Processor Interface (MIPI).

The second electronic device 100 may receive respective signals from the first electronic device 1 via a first reception terminal SL1, a second reception terminal SL2, and a third reception terminal SL3. The second electronic device 100 may include a first receiver 101, a second receiver 102, a third receiver 103, a data recoverer 110, a clock recoverer 120, a signal processor 130, a controller 140, and a calibrator 150.

The first receiver 101, the second receiver 102, and the third receiver 103 may respectively receive signals through the first reception terminal SL1, the second reception terminal SL2, and the third reception terminal SL3.

The first receiver 101 may output a first signal S1 based on a difference between a signal received through SL1 and a signal received through SL2. The second receiver 102 may output a second signal S2 based on a difference between a signal received through SL2 and a signal received through SL3. The third receiver 103 may output a third signal S3 based on a difference between a signal received through SL3 and a signal received through SL1.

The data recoverer 110 may receive the first signal S1, the second signal S2, the third signal S3, and a clock signal CLK. The data recoverer 110 may synchronize the first signal S1, the second signal S2, and the third signal S3 to the clock signal CLK to output a first received signal RS1, a second received signal RS2, and a third received signal RS3.

The clock recoverer 120 may receive the first signal S1, the second signal S2, and the third signal S3, along with a calibration value. The clock recoverer 120 may include a data transition detector 122 and a delay generator 121. The clock recoverer 120 may generate a clock signal CLK corresponding to the calibration value, and may recover the clock signal CLK such that real data is received using the calibration value obtained through the completed calibration process.

The signal processor 130 may receive the first received signal RS1, the second received signal RS2, the third received signal RS3, and the clock signal CLK, and may operate in response to the received signals RS1 to RS3. Signals processed by the signal processor 130 may be provided to the controller 140 as recovered data via a data path. In some examples, the signal processor 130 may perform functions of a symbol decoder and a deserializer.

The controller 140, upon completion of calibration, may receive real data using the clock signal generated based on the calibration value. The second electronic device 100 may perform a series of operations based on the received real data. A data path through which the real data is transmitted may be the same path as used during a calibration interval. That is, the disclosure utilizes a data path during the calibration interval, and the data path may be the same data path used for transmitting real data. The data path is reused for calibration.

The calibrator 150 may determine whether the recovered data passes or fails during preamble calibration, and may set a calibrated value to enable reception of valid data after the preamble calibration is completed. The calibrator 150 may use the calculated calibrated value to generate the clock signal CLK for real data transmission.

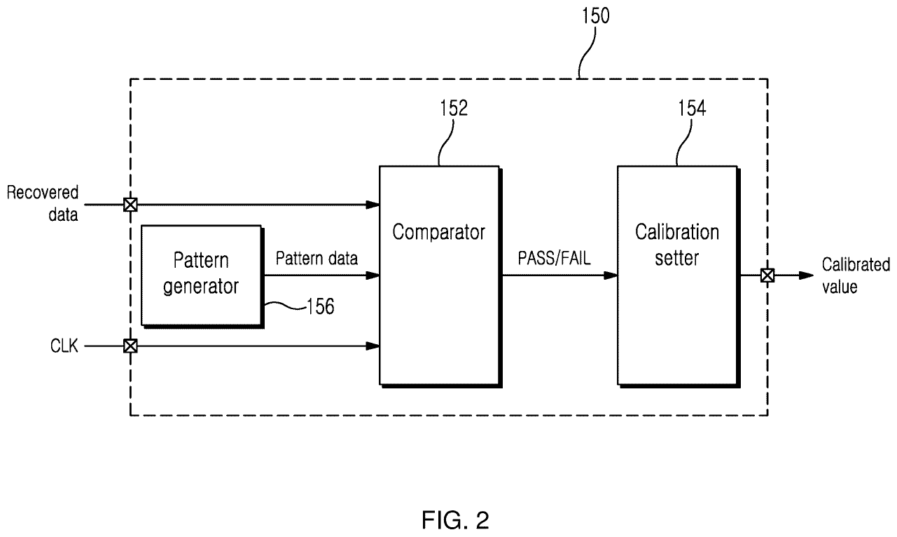

FIG. 2 is a block diagram illustrating a configuration of the calibrator shown in FIG. 1.

Referring to FIG. 2, a calibrator 150 may include a comparator 152, a calibration setter 154, and a pattern generator 156.

The comparator 152 may compare received data (i.e., recovered data) output from a signal processor 130 during preamble calibration with pattern data output from the pattern generator 156. Based on the comparison result, the comparator 152 may output whether the data matches or does not match. If the data matches, the comparator 152 may determine the received data to be in a pass state. Conversely, if the data does not match, the comparator 152 may determine the received data to be in a fail state.

The calibration setter 154 may set a calibration value so as to enable the generation of a clock signal for transmitting real data. In this example, the calibration setter 154 may set a midpoint of a pass region, determined based on the judgment result of the received data during preamble calibration, as the calibration value.

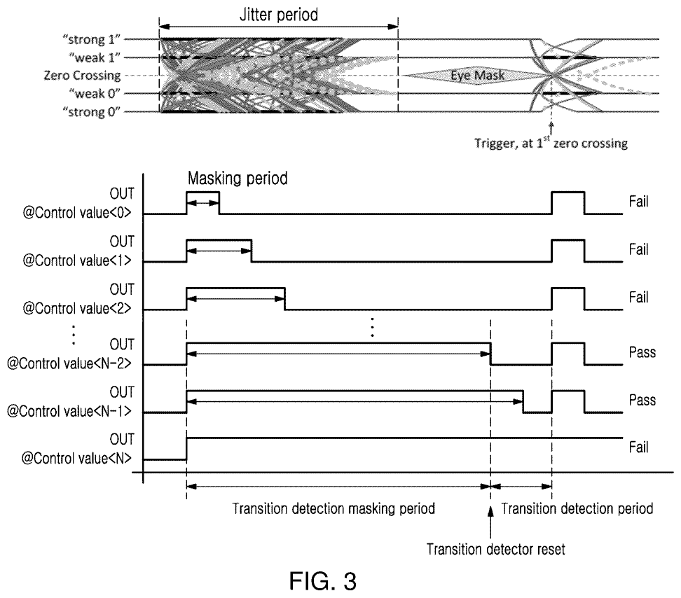

FIG. 3 is a timing diagram illustrating the concept of an eye mask and clock recovery.

A clock recoverer 120 may detect transitions in the input first to third signals S1, S2, S3 and generate a clock signal CLK based on the detected transitions. Referring to FIG. 3, jitter may occur at the first to third reception terminals SL1, SL2, SL3, and the clock recoverer 120 may malfunction due to the jitter. Accordingly, the clock recoverer 120 generates a masking period to eliminate the influence of jitter from the first to third reception terminals SL1, SL2, SL3 and thereby prevent malfunction of the clock recoverer 120. When the masking period is longer than the jitter period, the clock recoverer 120 can operate normally. In FIG. 3, it can be seen that the values having a pass state are OUT @ Control value<N−2> and OUT @ Control value<N−1>.

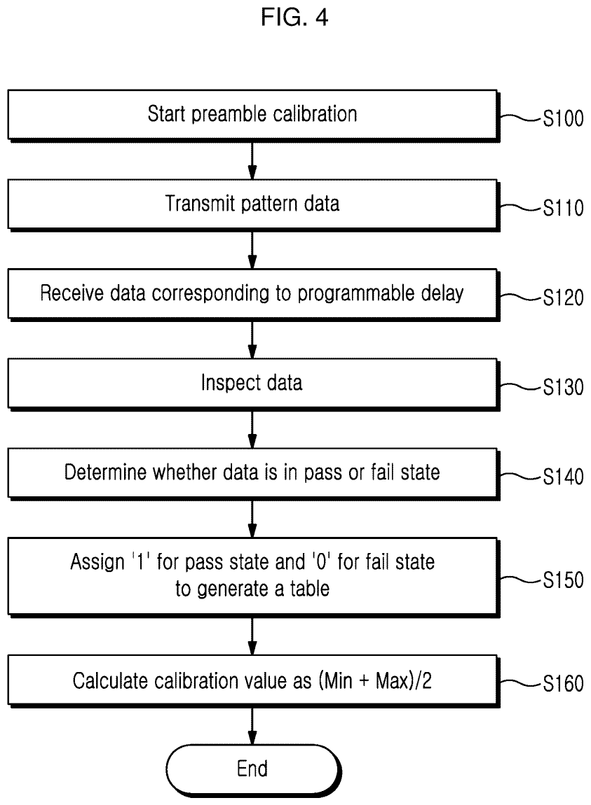

FIG. 4 is a flowchart illustrating a process by which a calibrator sets a calibration value according to the present disclosure.

Referring to FIG. 4, an electronic device 10 performs preamble calibration prior to the transmission of real data (S100). In the C-PHY specification, the preamble calibration period is defined as having a relatively simple pattern in which a symbol of ‘3’ or ‘1’ is repeated. After the preamble calibration is performed, valid data can be received using a recovered clock signal.

Once the preamble calibration has been completed, a portion of pattern data for calibration is transmitted prior to the transmission of real data (S110). The pattern data may correspond to a symbol ‘3’ or ‘1’. The pattern data performs only a simple transition (i.e., toggle), such that only a single transition occurs within one unit interval (UI), thereby enabling calibration to be performed.

Once the pattern data is transmitted, a calibrator 150 receives data (i.e., recovered data) corresponding to a programmable delay that allows calibration to be performed (S120). Subsequently, to prevent malfunctions caused by delay step changes during the preamble calibration period, the calibrator remains in a standby state during a guard period and performs data inspection during a data checking period by comparing the recovered data with the pattern data (S130). The data inspection checks whether the data is in a pass or fail state (S140). If the result of the inspection is a pass, the corresponding bit is considered to be a valid option for use in real data. The result of the inspection is recorded as ‘1’ for pass and ‘0’ for fail, and once the entire inspection is complete, the results are tabulated (S150). For example, the inspection results may be organized as shown in Table 1 below.

TABLE 1

| 0 | 1 | 2 | 3 | 4 | 5 | 6 | 7 | 8 | 9 | A | B | C | D | E | F |
|---|---|---|---|---|---|---|---|---|---|---|---|---|---|---|---|
| 0 | 0 | 1 | 1 | 1 | 1 | 1 | 1 | 1 | 1 | 1 | 1 | 1 | 1 | 0 | 0 |

Next, a calibrated value is calculated (S160). In this example, the calibrated value is calculated using a midpoint. Specifically, the calibrated value is based on the midpoint of a pass region. For example, as shown in Table 1, if the pass region spans from ‘2’ to ‘D’, a midpoint value such as ‘7’ or ‘8’ may be selected as the

$$\frac{Min + Max}{2} .$$

calibrated value. That is, the calibrated value may be calculated as Once the calibrated value is calculated, the preamble calibration is completed.

As described above, during the preamble calibration period, it is determined whether a pattern of ‘3’ or ‘1’ has been transmitted, and the received data is evaluated to determine whether it is in a pass state or a fail state. Based on the evaluation result, the calibrated value is set to the midpoint of the pass region. When a plurality of pass regions are present during the preamble calibration period, the calibrated value may be set to the midpoint of the relatively wider pass region in the example.

Meanwhile, when the pattern ‘3’ or ‘1’ is transmitted during the preamble calibration period, a programmable delay path may be changed. In such cases, jitter and glitches may occur. As previously described, jitter and glitches can interfere with proper clock generation and cause various operational issues. Therefore, it may be desired to address such problems.

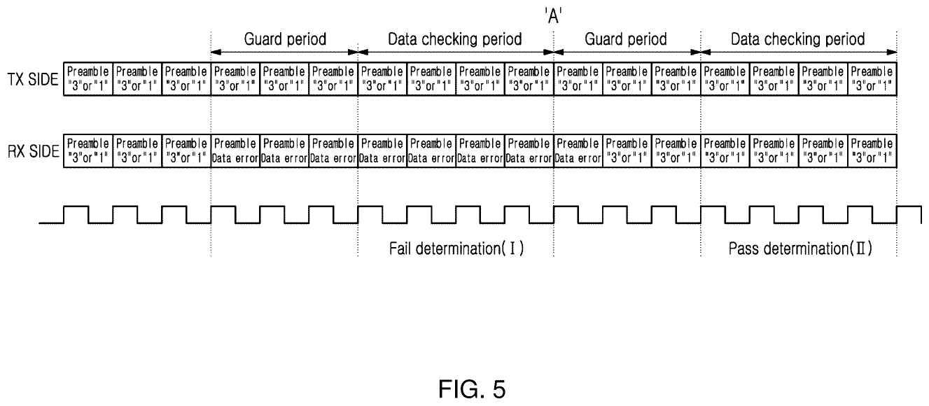

FIG. 5 is a diagram illustrating a sequence for performing preamble calibration according to the present disclosure.

Referring to FIG. 5, during the preamble calibration period, a guard period and a data checking period are included and sequentially repeated as part of the calibration sequence. Specifically, after one iteration of the guard period and the data checking period is completed, a delay step is changed at time point ‘A’, and the guard period and the data checking period are executed again in sequence.

The data checking period may be a period during which the pass or fail state of the received data (i.e., recovered data) is checked by comparing the received data with pattern data. Accordingly, if at least one data error occurs during the data checking period following the guard period, the corresponding delay step is determined to be in a fail state (region I). Conversely, if no data error occurs during the data checking period following the guard period, the corresponding delay step is determined to be in a pass state (region II).

The above-described sequence is performed for all delay steps included in the calibration period, and the optimal delay step is selected based on this sequence.

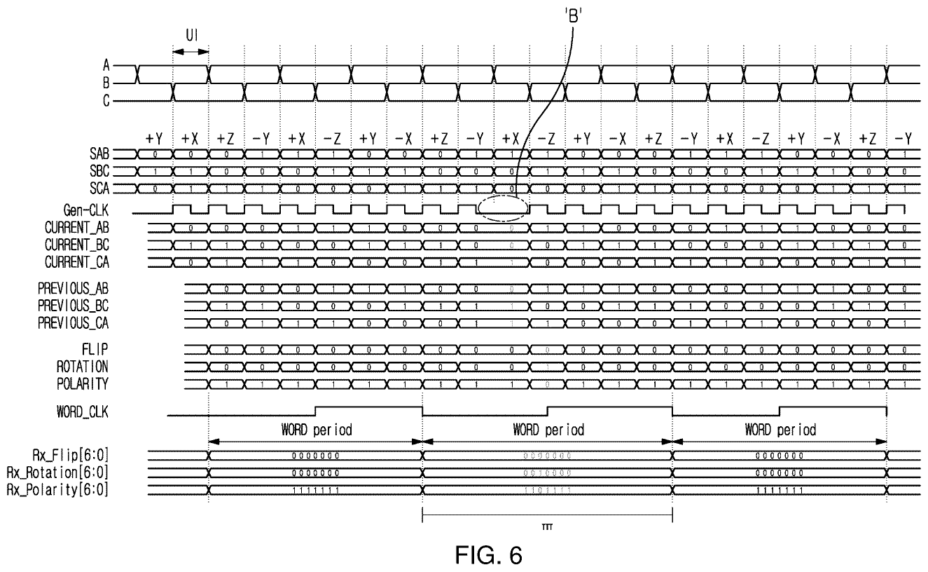

FIG. 6 is a diagram illustrating an example of determining a data fail state when a clock signal is not generated during preamble calibration according to the present disclosure.

During the preamble calibration period, calibration is performed under a normal clock signal such that only one transition occurs within a single data unit interval (UI).

However, there may be cases where the clock signal is not generated. For example, in region ‘B’ of FIG. 6, the clock signal may fail to be generated. In such a case, an additional symbol (e.g., FLIP, ROTATION, POLARITY) may be introduced due to the pattern ‘3’ or ‘1’, resulting in a relatively longer word period.

In this case, the received data may enter a fail state, as shown by sequences such as ‘0010000’ and ‘1101111’ in region III. In other words, when the word period becomes extended, it can be determined that a data error has occurred in the received data.

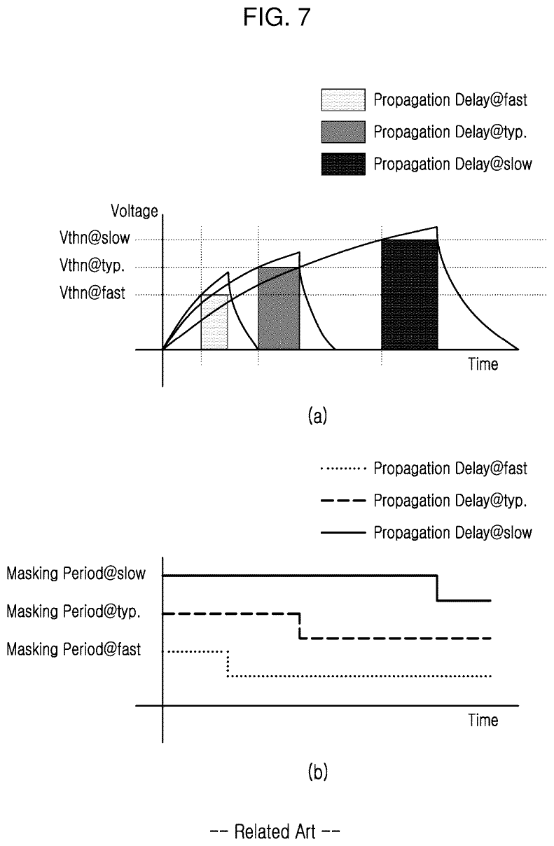

Meanwhile, the programmable delay path of a conventional electronic device for calibration is prone to significant variation due to changes in process, voltage, and temperature (PVT) conditions. The problems associated with such conventional techniques will be described with reference to FIG. 7.

FIG. 7 is a graph and timing diagram illustrating conditions of a programmable delay path under variations in process, voltage, and temperature (PVT) conditions.

Generally, in a programmable delay path, when the threshold voltage (Vthn) increases due to PVT variation, the device becomes slower (Vthn@slow), resulting in reduced current sourcing capability and a significantly increased delay time (Masking Period@slow). Conversely, when the threshold voltage (Vthn) decreases due to PVT variation, the device becomes faster (Vthn@fast), current sourcing capability improves, and the delay time becomes shorter (Masking Period@fast). Accordingly, a typical programmable delay path exhibits substantial variation in delay time depending on PVT conditions. For example, when the device slows down (Vthn@slow), the delay time may increase by approximately 2 to 3 times, whereas when the device speeds up (Vthn@fast), the delay time may decrease by approximately 1.5 to 2 times.

Due to this variation, a large number of circuits may be desired to ensure high resolution and a wide calibration range under such PVT conditions, which in turn causes a significant increase in the size of the programmable delay path.

Accordingly, the present disclosure proposes a programmable delay path that is insensitive to PVT variations.

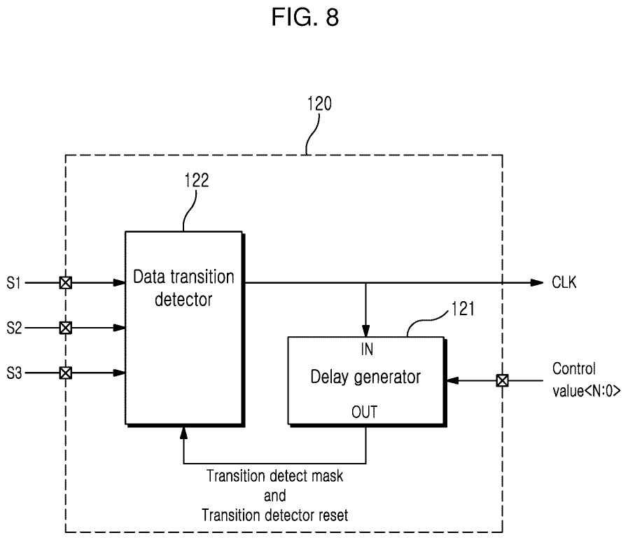

FIG. 8 is a block diagram illustrating a configuration of a clock recoverer 120 including a programmable delay path that is insensitive to PVT variation. The clock recoverer 120 includes a delay generator 121 and a data transition detector 122.

The data transition detector 122 detects the first transition among the first to third signals S1, S2, S3 from a high level to a low level or from a low level to a high level, and transitions a clock signal CLK to a low level in response thereto. The delay generator 121 generates a masking period using the clock signal CLK, which has transitioned to the low level, to prevent unintended data transitions caused by jitter at reception terminals SL1, SL2, SL3.

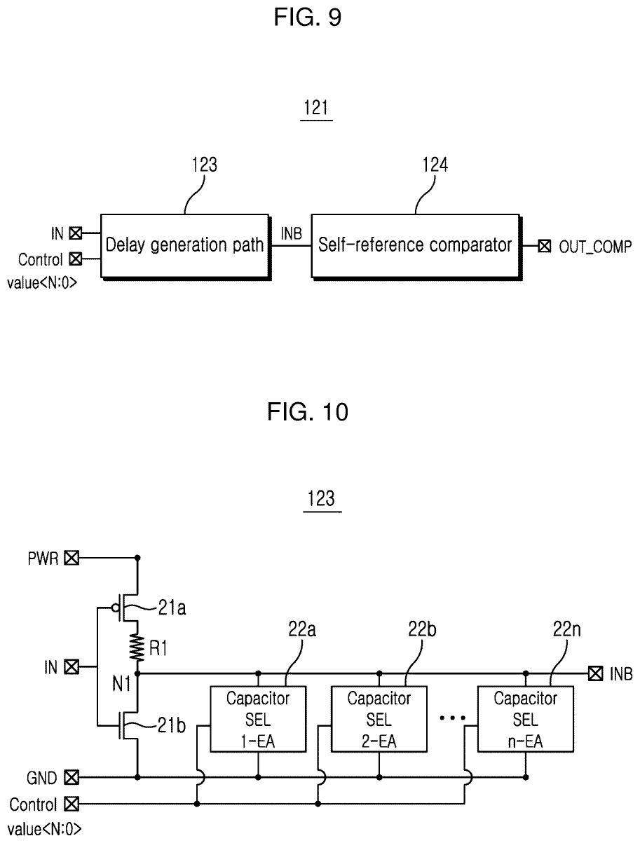

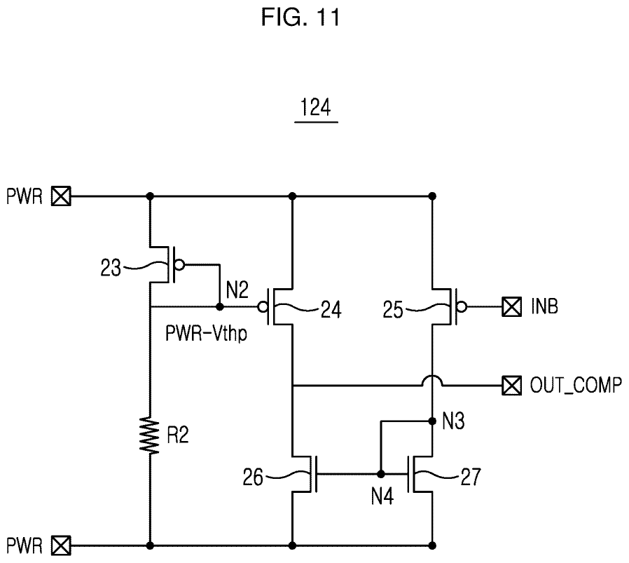

FIG. 9 is a block diagram illustrating a delay generator capable of providing a programmable delay path that is insensitive to PVT variation. FIG. 10 is a circuit diagram of a delay generation path included in the delay generator. FIG. 11 is a circuit diagram of a self-reference comparator included in the delay generator.

Referring to FIG. 9, a delay generator 121 may include a delay generation path 123 and a self-reference comparator 124. The delay generation path 123 receives a clock signal CLK through an input terminal IN, and receives a calibrated value through a control value input terminal (Control Value <N:0>) to select an appropriate delay path. The self-reference comparator 124 offsets PVT variations in the selected delay path and provides the compensated output.

Referring to FIG. 10, a delay generation path 123 may include a power terminal (PWR), an input terminal (IN), a ground terminal (GND), a control value input terminal (Control value<N: 0>), and an output terminal (INB).

A first MOSFET 21a and a second MOSFET 21b are connected in series between the power terminal (PWR) and the ground terminal (GND). A first resistor R1 having a predetermined resistance value is connected between the first MOSFET 21a and the second MOSFET 21b. A plurality of capacitor selectors 22a, 22b, . . . 22n are connected between a first node N1, which is located between the first MOSFET 21a and the second MOSFET 21b, and the output terminal (INB). A calibrated value is input to each of the capacitor selectors 22a to 22n via the control value input terminal (Control value<N: 0>).

In the example, the first MOSFET 21a may be a P-type MOSFET, and the second MOSFET 21b may be an N-type MOSFET. Alternatively, the first MOSFET 21a may be an N-type MOSFET, and the second MOSFET 21b may be a P-type MOSFET.

Referring to FIG. 11, a self-reference comparator 124 may include a third MOSFET 23 and a second resistor R2 connected in series between power terminals (PWR), a fourth MOSFET 24 and a sixth MOSFET 26 connected in series, and a fifth MOSFET 25 and a seventh MOSFET 27 connected in series, all of which are connected in parallel. The third, fourth, and fifth MOSFETs 23, 24, 25 may be P-type MOSFETs, and the sixth and seventh MOSFETs 26, 27 may be N-type MOSFETs.

The third MOSFET 23 may be configured in a diode-connected structure in which the gate terminal is connected to the drain terminal, so as to generate a threshold voltage (Vthp) of the third MOSFET 23 that varies in response to PVT conditions, and is connected to the fourth MOSFET 24 via a second node N2. The gate terminals of the sixth and seventh MOSFETs 26 and 27 may also be connected to each other. In addition, a third node N3 between the fifth MOSFET 25 and the seventh MOSFET 27 is connected to a fourth node N4 between the sixth MOSFET 26 and the seventh MOSFET 27. A signal input to an input terminal (INB), which is connected to the gate of the fifth MOSFET 25, is output to an output terminal (OUT_COMP).

The operation of a delay generator 121 having the above-described configuration is as follows.

In a delay generation path 123, when a first MOSFET 21a is in a turn-on state, the delay path is determined by the value of a first resistor R1 and the capacitance value of one capacitor C selected from among the plurality of capacitor selectors 22a, 22b, . . . 22n. According to the determined delay path, the voltage increases with a predetermined rising time.

At this time, variations in PVT conditions may cause performance fluctuations in the MOSFETs. To minimize such fluctuations, a self-reference comparator 124 uses a self-reference voltage (PWR-Vthp). When the self-reference comparator 124 receives the output of the delay generation path 123 via the input terminal INB, the fifth MOSFET 25 and the seventh MOSFET 27 perform turn-on/turn-off operations. As a result, the on/off state of the seventh MOSFET 27 is determined, and the logic level of the output terminal OUT_COMP is set to high or low accordingly. In this state, if the threshold voltage Vthp increases, the MOSFETs operate in a slower state and the current sourcing capability is reduced. The threshold voltage Vthp of the third MOSFET 23, which varies with PVT, is used to establish the self-reference voltage (PWR-Vthp), which is compared with the output INB of the delay generation path 123. In other words, as the threshold voltage Vthp increases, the MOSFETs become slower, and the self-reference voltage (PWR-Vthp) at the second node N2 decreases. Accordingly, although the devices become slower and the current sourcing capability is reduced, the self-reference voltage (PWR-Vthp) used for comparison with the output INB of the delay generation path 123 also decreases. As a result, the effect of PVT variation can be reduced.

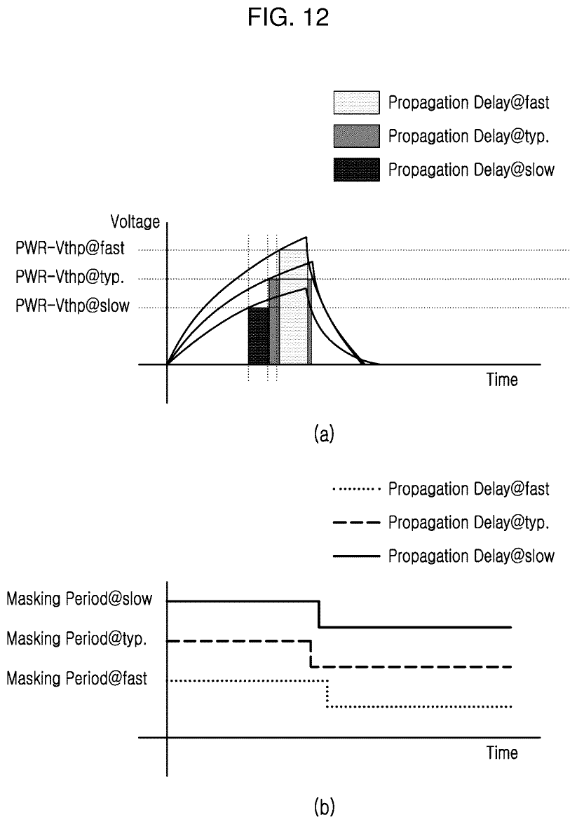

FIG. 12 is a graph and timing diagram illustrating the behavior of a programmable delay path under various conditions resulting from process, voltage, temperature (PVT) variation, according to the present disclosure.

In comparison with FIG. 7, which illustrates the conventional technology described earlier, it can be seen that, based on the delay time (x-axis), the extent of PVT variation has been significantly reduced.

That is, the delay generator 121 of FIG. 9 selects an appropriate delay path by using the first resistor R1 connected to the first MOSFET 21a and by selecting one of the available capacitor values. Thereafter, when the third MOSFET 23—which is of the same type as the first MOSFET 21a—enters a slow state, a low self-reference voltage (PWR-Vthp @ slow) is generated; when it enters a fast state, a high self-reference voltage (PWR-Vthp @ fast) is generated. In addition, the self-reference voltage (PWR-Vthp) is compared with the output INB of the delay generation path 123, thereby compensating for PVT-induced variation resulting from the current sourcing behavior of the first MOSFET 21a by using the threshold voltage variation of the third MOSFET 23. As a result, a programmable delay path that is insensitive to PVT variation can be provided.

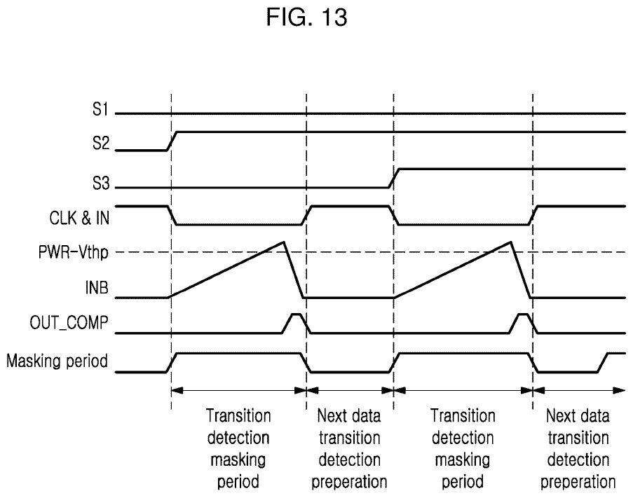

FIG. 13 is a timing diagram of a clock recoverer including the delay generator that is insensitive to PVT variation.

When first to third signals S1, S2, S3 are input to a data transition detector 122, a data transition is detected. Based on the detected transition, the clock signal (CLK) is driven to a low level, and the transitioned clock signal is applied to a delay generation path 123. Using a first MOSFET 21a, a first resistor R1, and one of the capacitor selectors 22a, 22b, . . . 22n in the delay generation path 123, a rising signal that includes PVT variation is generated. This signal is then compared with a self-reference voltage using a self-reference comparator 124, thereby providing a programmable delay path that is insensitive to PVT variation.

Simulation results comparing the conventional structure and the structure of the present disclosure are shown in Table 2. Table 2 compares the conditions of a programmable delay path implemented using a general cell—such as a conventional inverter chain—under identical PVT conditions, with those of the programmable delay path implemented using the delay generator of the present disclosure as illustrated in FIG. 8.

TABLE 2

| | Conventional Structure | Structure of the Present Disclosure |
|---|---|---|
| | Delay Time | Delay Time |
| Condition 1: PVT best case | 71.37 | 126.03 |
| (Propagation delay @fast) | | |
| Condition 2: PVT typical case | 100.00 | 100.00 |
| (Propagation delay @typical) | | |
| Condition 3: PVT worst case | 230.71 | 111.16 |
| (Propagation delay @slow) | | |
| Variation ratio (%) compared to PVT typical case | $\frac{230.71 - 71.37}{100.} \times 100 = 159.34 \%$ | $\frac{126.03 - 111.16}{100.} \times 100 = 14.87 \%$ |

Referring to Table 2, the conventional structure exhibits a variation of 159.34% relative to Condition 2, the PVT typical case, whereas the structure according to the present disclosure shows a reduced variation ratio of 14.87% under the same condition.

As described above, the present disclosure applies a data path designed for transmitting real data to the calibration operation between electronic devices, thereby minimizing the additional hardware desired for calibration. Furthermore, by configuring a delay cell that is insensitive to PVT variation in the clock recoverer of the second electronic device that performs calibration, it is possible to reduce the area of the clock recoverer and, consequently, the electronic device incorporating the unit.

According to the present disclosure, by applying a data path—originally designed for transmitting real data—to the calibration operation between electronic devices, it is possible to minimize the additional hardware desired for calibration and improve calibration coverage.

According to the present disclosure, by configuring a delay cell that is insensitive to variation caused by process, voltage, and temperature (PVT) in the clock recoverer of the second electronic device that performs calibration, the circuitry desired for compensating PVT variation can be minimized, thereby reducing the area of the clock recoverer and the electronic device in which the unit is implemented.

The first electronic device 1, the second electronic device 100, the first receiver 101, the second receiver 102, the third receiver 103, the data recoverer 110, the clock recoverer 120, the signal processor 130, the controller 140, the calibrator 150, the comparator 152, the calibration setter 154, the pattern generator 156, the delay generator 121, the data transition detector 122, the delay generation path 123, and the self-reference comparator 124 described herein, including descriptions with respect to respect to FIGS. 1-6 and 8-13, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 and 8-13 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An electronic device comprising:
a first electronic device and a second electronic device configured to transmit and receive signals based on a C-PHY protocol, the second electronic device comprising:
a calibrator configured to receive recovered data via a data path used to receive real data and provide a calibration value; and
a clock recoverer configured to recover a clock signal (CLK) using the calibration value.

2. The electronic device of claim 1,
wherein the calibrator comprises:
a pattern generator configured to output pattern data;
a comparator configured to compare the recovered data transmitted through the data path with the pattern data and output a pass or fail status value of the recovered data; and
a calibration setter configured to set the calibration value to a midpoint value of a pass region among the output values of the comparator.

3. The electronic device of claim 2,
wherein the calibration setter is configured to count a number of pass regions during preamble calibration, and, in response to two or more of the pass regions being detected, set the calibration value to a midpoint value of a longer one of the pass regions.

4. The electronic device of claim 3,
wherein the pass or fail status is determined based on whether synchronization between the recovered data and the pattern data is achieved.

5. The electronic device of claim 1, further comprising:
a plurality of receivers configured to receive a plurality of signals, respectively, from the first electronic device;
a data recoverer configured to output the plurality of received signals in synchronization with the clock signal recovered by the clock recoverer; and
a signal processor configured to transmit the recovered data to a controller based on the clock signal and the plurality of received signals.

6. The electronic device of claim 5,
wherein, after completion of preamble calibration, the controller is configured to receive the real data using a clock signal generated based on the calibration value set by the calibrator.

7. The electronic device of claim 1,
wherein the calibrator is configured to perform a guard period and a data checking period during preamble calibration, and determine that the recovered data is in a fail state in response to at least one data error occurring during the data checking period.

8. The electronic device of claim 1,
wherein the calibrator is configured to determine that the recovered data is in a fail state in response to the clock signal being missing during preamble calibration.

9. The electronic device of claim 1,
wherein the clock recoverer comprises a data transition detector and a delay generator, and
wherein the delay generator comprises a delay generation path and a self-reference comparator, and is configured to minimize variations due to process, voltage, and temperature (PVT).

10. The electronic device of claim 9,
wherein the delay generation path comprises:
a power terminal and a ground terminal;
a first MOSFET and a second MOSFET connected in series between the power terminal and the ground terminal;
a first resistor connected between the first MOSFET and the second MOSFET; and
two or more capacitor selectors connected between a first node between the first MOSFET and the second MOSFET and an output terminal, and
wherein the first resistor and the capacitor selectors are configured to provide an optimal delay path.

11. The electronic device of claim 9,
wherein the self-reference comparator offsets the variations due to PVT using a MOSFET having a gate terminal connected to a drain terminal.

12. The electronic device of claim 9,
wherein the self-reference comparator comprises third to seventh MOSFETs configured to operate based on an output of the delay generation path; and a second resistor connected in series with the third MOSFET, and is configured to provide a self-reference voltage for level transition of a clock signal using a threshold voltage of the third MOSFET.

13. An electronic device comprising:
a first electronic device and a second electronic device configured to transmit and receive signals based on a C-PHY protocol,
wherein the second electronic device comprises:
a clock recoverer, configured to recover a clock signal (CLK) using a calibration value, comprising a data transition detector and a delay generator, and
wherein the delay generator comprises a delay generation path and a self-reference comparator, and is configured to minimize variations due to process, voltage, and temperature (PVT).

14. The electronic device of claim 13,
wherein the delay generation path comprises:
a power terminal and a ground terminal;
a first MOSFET and a second MOSFET connected in series between the power terminal and the ground terminal;
a first resistor connected between the first MOSFET and the second MOSFET; and
two or more capacitor selectors connected between a first node between the first and second MOSFETs and an output terminal, and
wherein the delay generation path is configured to provide an optimal delay path by the first resistor and the capacitor selectors.

15. The electronic device of claim 13,
wherein the self-reference comparator offsets variations due to PVT using a MOSFET having a gate terminal connected to a drain terminal.

16. The electronic device of claim 13,
wherein the self-reference comparator comprises:
third to seventh MOSFETs configured to operate based on an output of the delay generation path; and
a second resistor connected in series with the third MOSFET,
and is configured to provide a self-reference voltage for level transition of a clock signal using a threshold voltage of the third MOSFET.

17. A calibration method using an electronic device, the method comprising:
performing a preamble calibration;
receiving, by a second electronic device, pattern data from a first electronic device;
receiving recovered data corresponding to a programmable delay upon transmitting the pattern data;
identifying a data-pass region based on a result of evaluating the received recovered data; and
setting a midpoint value of the data-pass region as a calibration value and transmitting the calibration value to a clock recoverer.

18. The calibration method claim 17,
wherein, in response to a plurality of data-pass regions being identified, setting a midpoint value of a widest one of the data-pass regions as the calibration value.

19. The calibration method of claim 17,
wherein the second electronic device performs the preamble calibration by repeatedly alternating between a guard period and a data checking period, and determines that the recovered data is in a fail status in response to at least one data error occurring during the data checking period.

20. The calibration method of claim 17,
wherein, in response to a clock signal missing during the preamble calibration, the second electronic device determines that the recovered data is in a fail status.
